(19) United States
(12) Patent Application Publication
(10) Pub. No.: US 2012/0080457 A1
(43) Pub. Date: Apr. 5, 2012

(54) POWDER DELIVERY SYSTEM

(76) Inventors: Robert A. Lovinger, Savage, MN (US); Bradford G. Bass, Mankato, MN (US); Stuart J. Olstad, Plymouth, MN (US)

(21) Appl. No.: 13/251,447

(22) Filed: Oct. 3, 2011

Related U.S. Application Data
(60) Provisional application No. 61/389,017, filed on Oct. 1, 2010.
(60) Provisional application No. 61/445,278, filed on Feb. 22, 2011.

(51) Int. Cl. B05B 11/02; B05B 11/06

(52) U.S. Cl. 222/633; 222/632; 222/530; 222/565

(57) ABSTRACT

A delivery system for delivery of powders to targeted areas. Various embodiments include a powder delivery train that mates with standard-sized powder containers. Another embodiment includes a bellows container that contains the powder and propels the powder through the powder delivery train. Another embodiment integrates the powder delivery train with the sifter cap and enables the powder delivery tube to be stowed within the powder container.

### RELATED APPLICATIONS

This application claims the benefit of U.S. Provisional Application No. 61/389,107, filed Oct. 1, 2010, and U.S. Provisional Application No. 61/445,278, filed Feb. 22, 2011, each of which is hereby fully incorporated herein by reference.

### FIELD OF THE INVENTION

The present invention relates generally to powder delivery systems. More specifically, embodiments of the present invention are directed to targeted delivery of health and body powders.

### BACKGROUND OF THE INVENTION

The use of powders is recognized as a way to reduce problems associated with continuous or rubbing contact with the skin and for odor control. Such problems include general chafing and bed sores. Application of body powders generally involves rubbing the powders over or into a targeted area by hand. For example, health care professionals who care for bed ridden individuals must often position and unclothe individuals in order to access areas to be powdered. The health care professional must then apply the powder to his or her hands in order to transfer the powder to the patient. Because the health care professional's hands are occupied with the powder application, it is often necessary to have a second person present to maintain the position of the patient.

In the hot weather, construction workers, athletes, and service personnel often experience chafing in areas such as the groin, upper thighs and upper arms. Those suffering from obesity also experience chafing. Often, however, renewed application of body powders is precluded because the individual is inhibited from accessing such private areas while on the job. In some applications, existing powder dispensary techniques are inefficient, consuming more powder than necessary with less effect than desired. For example, those who utilize powders in foot ware can encounter difficulty in reliably powdering the interior toe areas of the foot ware.

Devices and techniques that facilitate the dispensing of powders in such circumstances would be welcomed.

### SUMMARY OF THE INVENTION

Various embodiments of the invention are capable of delivering powder to a small target area in hard to reach places. Often, the powder can be applied to the target area quickly and in a discrete manner, thus allowing application of the powder in public. Certain embodiments of the invention can be adapted for use with standard-sized or “conventional” sifter caps, thus negating the need to transfer the powder to a special container.

Some embodiments of the invention find utility in the care of the elderly or bedridden patients, and/or for individuals to access hard to reach places generally. Embodiments of the invention can be utilized to apply powder to target areas while reducing the degree of positioning and unclothing, and to do so with one hand, thus freeing up a hand for maintaining the position of the patient. In other applications, various embodiments of the invention enable users to self administer body powder to areas under the clothing without need for removing the clothing and without need of transferring the powder to the user's hands first.

Structurally, a powder delivery cap system in one embodiment of the invention comprises a cylindrical cap that defines a central axis, the cylindrical cap including a top portion, a continuous skirt portion that depends from the top portion, a port that passes through the top portion, and a delivery tube operatively coupled with the port. The skirt portion can include a continuous flexible seal portion having a softer durometer hardness than the top portion. The skirt portion defines an opening opposite the top portion that is dimensioned for coupling with and sealing against the perimeter of a sifter cap that can be operatively coupled with a powder container. The delivery tube has a proximal end and a distal end, the delivery tube being coupled with the port so that the proximal end of the delivery tube can be adapted for fluid communication with the interior of the powder container. A nozzle can be selectively attached to the distal end of the delivery tube.

In operation, a user couples the powder delivery cap system to the powder container by affixing the cylindrical cap to either the sifter cap that often caps powder containers or to the opening of the container itself. Powder can be caused to flow through the delivery tube to the target area by squeezing the powder container.

In one embodiment, the delivery tube is adapted for retraction into the powder container for stowage when not in use.

In another embodiment, a special bellows container is utilized instead of a standard powder container. The bellows container can be configured and dimensioned ergonomically for hand operation. The bellows container can also be designed for efficient removal of powder therefrom.

### BRIEF DESCRIPTION OF THE DRAWINGS

FIG. 1 is a perspective view of a powder delivery system utilizing a powder container in an embodiment of the invention;

FIGS. 2A and 2B are perspective views of a powder delivery train including a clip for mooring the powder delivery tube in an embodiment of the invention;

FIGS. 3A and 3B are perspective views of a powder delivery train in an embodiment of the invention;

FIGS. 4A and 4B are perspective views of a powder delivery train having tabbed clamps in an embodiment of the invention;

FIGS. 5A and 5B are perspective views of a combination powder delivery train/sifter cap with retractable delivery tube in an embodiment of the invention;

FIG. 5C is a sectional view of the powder delivery train of FIG. 5A;

FIG. 6A is a sectional view of a combination powder delivery train/sifter cap with retractable delivery tube in an embodiment of the invention;

FIG. 6B is an enlarged, partial sectional view of the combination powder delivery train/sifter cap of FIG. 6A prior to engagement of the delivery tube with the sifter cap;

FIG. 6C is an enlarged, partial sectional view of the combination powder delivery train/sifter cap of FIG. 6A after engagement of the delivery tube with the sifter cap;

FIG. 6D and 6E are sectional views of the combination powder delivery train/sifter cap of FIG. 6A;

FIG. 7 is a is an enlarged, partial sectional view of a combination powder delivery train/sifter cap with a LUER lock adapter in an embodiment of the invention;

FIG. 8A is a sectional view of a powder container with a combination powder delivery train/sifter cap having a retractable powder delivery tube in the retracted position;

FIG. 8B is a sectional view of the powder container of FIG. 8A with the retractable powder delivery tube in an extended position;

FIG. 9A is a partial top view of a powder container with a 3-position sifter cap in the closed position;

FIG. 9B is a partial top view of the powder container with the 3-position sifter cap of FIG. 9A with the sifter apertures opened and the powder delivery train access closed;

FIG. 9C is a partial top view of the powder container with the 3-position sifter cap of FIG. 9A with the sifter apertures closed and the powder delivery train access opened;

FIG. 9D is a sectional view of the powder container and 3-position sifter cap in the position of FIG. 9B;

FIG. 9E is a sectional view of the powder container and 3-position sifter cap in the position of FIG. 9C;

FIG. 10A is a perspective view of a powder delivery system in an embodiment of the invention;

FIG. 10B is a partial perspective view of the powder delivery system of FIG. 10A;

FIG. 11A is a perspective view of interchangeable end effectors for use with LUER lock systems in embodiments of the invention; and

FIG. 11B is a perspective view of numerous interchangeable powder delivery tubes in embodiments of the invention.

### DETAILED DESCRIPTION OF CERTAIN EMBODIMENTS

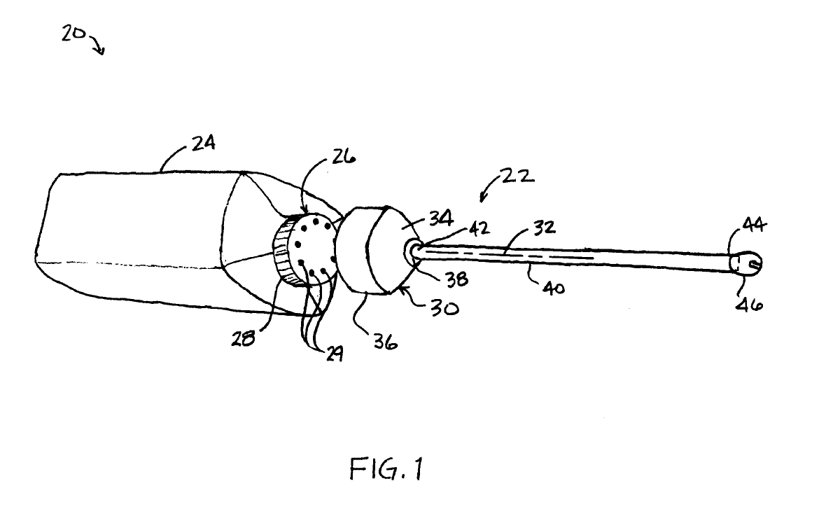

Referring to FIG. 1, a powder delivery system 20 comprising a powder delivery train 22 for coupling with a powder container 24 having a standard-sized or “conventional” sifter cap 26 is depicted in an embodiment of the invention. Examples of standard-sized powder containers and conventional sifter caps are manufactured by SKS Bottle and Packaging, Inc. of Watervliet, New York, USA. See http://www.sks-bottle.com/340c/fin55.html, last visited on Sep. 23, 2011, which is incorporated by reference herein except for express definitions contained therein. The sifter cap 26 is characterized as having an outer perimeter 28 and egress apertures 29 that can be selectively opened to enable powder flow therethrough. The powder delivery train includes a cylindrical cap 30 that defines a central axis 32, the cylindrical cap 30 comprising a top portion 34 and a skirt portion 36. A port 38 is formed in the top portion 34 of the cylindrical cap 30. A delivery tube 40 having a proximal end portion 42 and a distal end portion 44 is operatively coupled to the port 38, so that when the delivery train 22 is coupled with the powder container 24, the delivery tube 40 is in fluid communication with the interior of the container 24. A nozzle 46 can also be coupled with the distal end portion 44 of the powder delivery train 22.

The skirt portion 36 can be formed of a flexible material and dimensioned to provide a friction fit about the outer perimeter 28 of the sifter cap 26. The top portion can be a of a harder plastic material. The skirt portion 36 can comprise a softer plastic tubing such as TYGON, PVC tubing or rubber that is affixed to the top portion 34. Alternatively, the skirt portion 36 can be integral with the top portion 34 by a process such as overmolding.

In operation, the skirt portion 36 of the powder delivery train 22 is coupled to the outer perimeter 28 of the sifter cap 26 of the powder container 24. The flexible material of the skirt portion 36 provides a seal between the outer perimeter 28 of the sifter cap 26 and the cylindrical cap 30. Upon squeezing the powder container 24, powder from the container 24 enters the cylindrical cap 30 and flows through the delivery tube 40, exiting the nozzle 46. In one embodiment, the delivery tube 40 may be of a flexible material so that the delivery tube 40 may assume a tortuous form in order to access a target area that is otherwise hard to reach.

Referring to FIGS. 2A and 2B, a second powder delivery train 50 is depicted in an embodiment of the invention. The powder delivery train 50 has many of the same components and aspects as the powder delivery train 22, which are like-numbered in both FIGS. 1 and 2A and 2B. The port 38 of the powder delivery train 50 is offset from the central axis 32 of the cylindrical cap 30. A clip portion 54 extends from one side of the top portion 34 of the cylindrical cap, dimensioned to securely grip a portion of the delivery tube 40 at or near the distal end portion 44.

Functionally, having the port 38 offset from the central axis 32 can enable the powder to more efficiently exit the powder container without having to orient the powder container in a vertical orientation. When the delivery tube 40 is secured to the the clip portion 54, the delivery tube 40 is held in a prone position that creates a kink 56 in the delivery tube 40. The kink 56 can obstruct the delivery tube 40 that greatly reduces or cuts off spurious flow of powder therethrough.

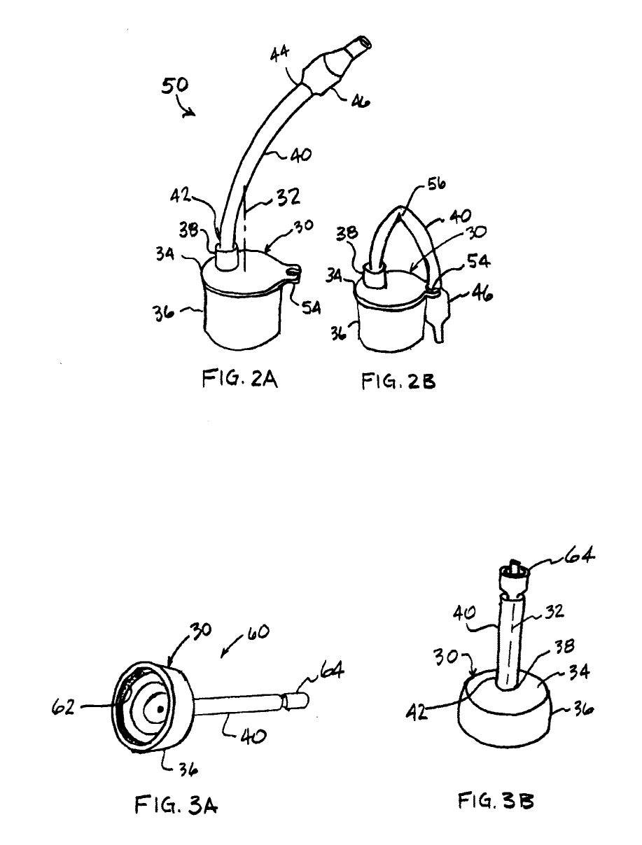

Referring to FIGS. 3A and 3B, a third powder delivery train 60 is depicted in an embodiment of the invention. Again, similar components and aspects that powder delivery train 60 shares with powder delivery trains 22 and 50 are like-numbered. In one embodiment, the skirt portion 36 can be of the same hardness as the top portion 34, and house a sealing member 62 such as a gasket or an o-ring that provides a seal between a powder container (e.g. powder container 24) and the powder delivery train 60. In one embodiment, the delivery tube 40 is equipped with a LUER fitting for coupling with various end effectors. Other fittings can be used, such as a snap fitting, friction fitting, barb fitting, spur fitting or threaded fitting. The skirt portion 36 and sealing member 62 can be configured and dimensioned to slide over the outer perimeter 28 of the sifter cap 26 (FIG. 1) to provide a substantial seal as well as a friction fit between the cylindrical cap 30 and the sifter cap 26. Alternatively, the sealing member 62 can be located within the cylindrical cap 30 to form a substantial seal on the top of the sifter cap 26 between the outer perimeter and the egress apertures 29, with the skirt 36 configured and dimensioned to snap fit or press fit over the perimeter 28 of the sifter cap 26.

The axial length of the skirt portion 36 for the powder delivery trains 22, 50 and 60 can be dimensioned so that a mixing chamber (not depicted) of ample size is created between the sifter cap 26 and the top portion 34 of the cylindrical cap 30. The mixing chamber prevents powder from being compacted within the cylindrical cap 30 and provides a plenum for pressurization of the powder as well as powder back flow during venting.

In one embodiment (not depicted), the cylindrical cap 30 includes a vent for air intake during operation. The vent can comprise a 1-way valve, such as a flapper valve, disposed on the top portion 34 or the skirt portion 36 of the cylindrical cap.

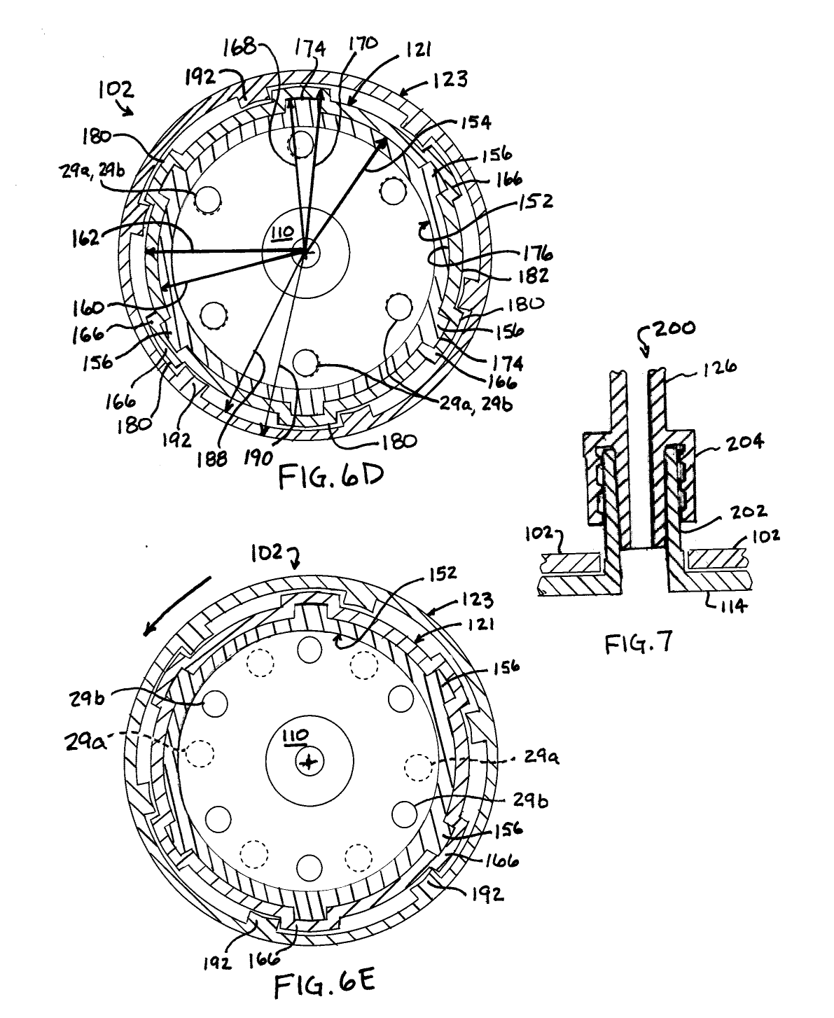

While the depictions and descriptions of FIGS. 1 through 3 include a sifter cap, certain embodiments of the invention to not require the presence of the sifter cap 26. That is, the sifter cap can be removed and the aforementioned sealing between the cylindrical cap 30 and the powder container 24 can be affected against the neck or mouth of the resulting opening (see, e.g., FIG. 6A). In one embodiment, the skirt portion 36 can be configured to mate with exterior threads that on the outer perimeter of the container opening to secure the cylindrical cap 30 to the powder container 24.

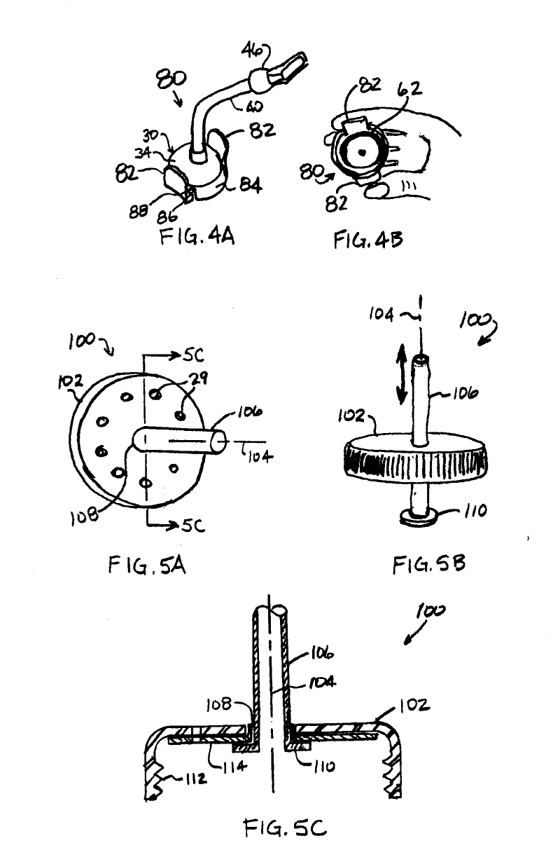

Referring to FIGS. 4A and 4B, a powder delivery train 80 including tabbed clamps 82 is depicted in an embodiment of the invention. The cylindrical cap 30 includes non-continuous skirt portion 84 characterized by axial slots 86 formed therein to define a living hinge 88 between the top portion 34 of the cylindrical cap 30 and each of the tabbed clamps 82. In the depicted embodiment, the sealing member 62 is coupled with the top portion 34 to form a substantial seal on the top of the sifter cap 26 between the outer perimeter and the egress apertures 29. The tabbed clamps 82 are configured and dimensioned to grip the outer perimeter 28 and/or the bottom of the outer perimeter 28 of the sifter cap 26 to maintain the sealing member 62 in contact with the top of the sifter cap 26.

In assembly, the tops of the tabbed clamps 82 are squeezed toward each other, as depicted in FIG. 4B, so that the bottoms of the tabbed clamps 82 rotate away from each other. The cylindrical cap 30 is then pressed onto the sifter cap 26 so that the sealing member 62 is seated against the top of the sifter cap 26. The tabbed clamps 82 are then released so that the lower portions of the tabbed clamps 82 clip to the outer perimeter 28 of the sifter cap 26.

Alternatively, the bottoms of the tabbed clamps can be configured to with inclined surfaces (not depicted) that ride against the outer perimeter 28 of the sifter cap 26 as the cylindrical cap 30 is slid over sifter cap 36. In this way, the bottoms of the tabbed clamps 82 can spread apart automatically by the action of installing the cylindrical cap 30 onto the sifter cap 26, and can be configured and dimensioned to clip into place once the sealing member 62 is seated against the top of the sifter cap 26. By this mechanism, it is not necessary to squeeze the top portions of the tabbed clamps toward each other during installation of the cylindrical cap 30. Also, the tops of the tabbed clamps 82 as depicted herein can be eliminated so that the clamps 82 are flush with the top portion 34 of the cylindrical cap 30.

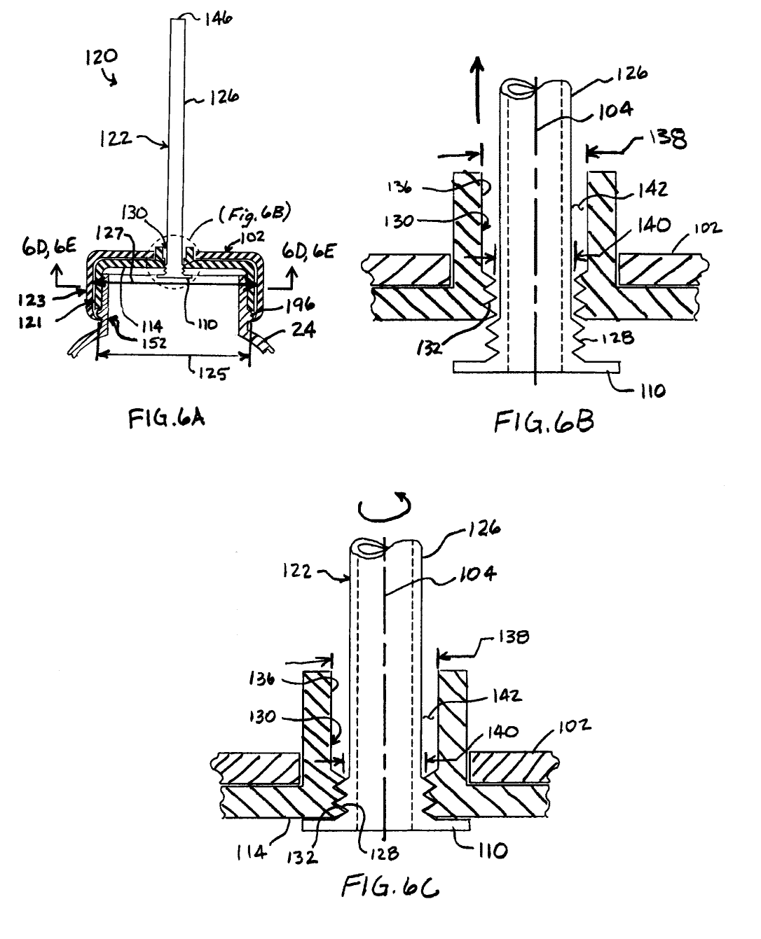

Referring to FIGS. 5A, 5B and 5C, a combination sifter cap/delivery tube 100 is depicted in an embodiment of the invention. The combination sifter cap/delivery tube 100 includes a sifter cap 102 that defines a central axis 104 with a delivery tube 106. The delivery tube 106 is disposed in an orifice 108 that can be substantially aligned with the central axis 104 as depicted. In the depicted embodiment, the delivery tube 106 can be selectively retracted into the powder container. The delivery tube 106 can include a flange 110 that registers against the inside of the sifter cap 102 when the delivery tube 106 is in the extended position. In some embodiments, the sifter cap 102 includes threads 112 for direct coupling to the powder container (e.g., powder container 24 of FIG. 1).

In operation, the combination sifter cap/delivery tube 100 replaces the sifter cap 26 of the powder container 24 (FIG. 1). When in use, the delivery tube 106 is extended outward from the powder container 24 until the flange 110 registers against an interior surface 114 of the sifter cap 102. The flange 110 can provide a barrier against powder flowing outward through the orifice 108 at the base of the delivery tube 106. When not in use, the delivery tube 106 can be retracted into the powder container 24 to maintain a low profile. The sifter cap 102 can then be used in substantially the same manner as a normal sifter cap.

Additionally or alternatively, an axial seal member (not depicted), such as a grommet can be implemented between the delivery tube 106 and the sifter cap 102. The axial seal member can be dimensioned to provide a degree of friction with the delivery tube 106 that holds the delivery tube at a substantially fixed axial position during operation, yet can be readily overcome by the operator for extraction/retraction of the delivery tube 106.

Referring to FIGS. 6A, 6B and 6C another combination sifter cap/delivery tube 120 with integrated powder delivery train 122 is depicted in an embodiment of the invention. Aspects in common with the combination sifter cap/delivery tube 100 of FIGS. 5 are similarly numbered. In the depicted embodiment, the sifter cap 102 includes an inner cap 121 and an outer cap 123 fitted to a neck portion 152 of the container 24. A lower portion 124 of the exterior or outer cap defines an opening diameter 125 that is reduced relative to an interior diameter 127 of the outer cap 123.

The combination sifter cap/delivery tube 120 includes a delivery tube 126 includes male thread 128 adjacent the flange 110 and the sifter cap 102 includes a threaded orifice 130 having female thread 132 adjacent the interior surface 114. In one embodiment, a distal portion 136 of the threaded orifice 130 can have an inner diameter 138 that is greater than an inner diameter 140 of the female thread 132, defining an annulus 142 therebetween.

In operation, the delivery tube 126 is pulled though the threaded orifice 130 until the male thread 128 of the delivery tube 126 contacts the female thread 132 of the threaded orifice 130 (FIG. 6B). The delivery tube 126 can then be rotated so that the male thread 128 of the delivery tube 126 engages the female thread 132 of the threaded orifice 130 (FIG. 6C). The threaded arrangement can be configured so that the flange 110 is secured against the interior surface 114 when the delivery tube 126 is fully engaged with the threaded orifice 130.

Functionally, the threaded engagement between the delivery tube 126 and the threaded orifice 130 secures the delivery tube 126 in place, prevents powder from seeping out of the orifice 130 during operation, and prevents the delivery tube 126 from being pushed back into the powder container during operation. Embodiments that define the annulus 142 provide a registration site for a cap (not depicted) that can be placed over a distal end 146 of the delivery tube 126 when the delivery tube 126 is stowed in a retracted position. When the delivery tube 126 is stowed, the sifter cap 102 can be operated in substantially the same manner as a normal sifter cap. The annulus 142 also provides access to grip the distal end 146 of the delivery tube 126 for extension of the delivery tube 126 when the cap is removed.

Other structures can be utilized to secure the delivery tube in the extended position, such as a snap fit, a detent structure or a flared frustum shape proximate the flange that provides a tight interference between the delivery tube and the orifice in the extended position.

Referring to FIGS. 6D and 6E, additional details of the inner cap 121, the outer cap 123 and the neck portion 152 of the container 24 are presented in an embodiment of the invention. The neck portion 152 defines an outer radius 154 and a plurality of protrusions 156 that project radially outward from the outer radius 154. The inner cap 121 includes a set of egress apertures 29b and defines an innermost inner radius 160 and an innermost outer radius 162.

In the depicted embodiment, the inner cap 121 includes a plurality of segments 166 that define an outermost inner radius 168 and an outermost outer radius 170. The segments 166 also define recesses 174 along an inner contour 176 of the inner cap 121 and outward protrusions 180 along an outer contour 182 of the inner cap 121. The recesses 174 are accessible from the opening diameter 125 of the outer cap 123 and are dimensioned to slide over the protrusions 156 of the neck portion 152 of the container 24. The outer cap 123 defines an inner radius 188 and an outer radius 190 and includes inward protrusions 192 that project radially inward from the inner radius 188. The egress apertures 29a are also defined on the outer cap 123.

In assembly, the inner cap 121 is disposed within the outer cap 123 and the delivery tube 126 is fed through the threaded orifice 130. The recesses 174 of the inner cap 121 are then aligned with the protrusions 156 of the neck portion 152 and the inner cap 121 slid over the protrusions 156. The outer cap 123 can then pressed onto the neck portion 152 and snapped over a detent 196 (FIG. 6A) that rings the neck portion 152 of the container 24. The inner cap 121 is thereby captured between the outer cap 123 and the detent 196. The protrusions 156 of the neck portion 152 rotationally lock the inner cap 121 in a fixed relationship with the neck portion 152.

The outer cap 123 is dimensioned to rotate about the inner cap 121 and the detent 196.

In operation, the sifter cap has two operating positions: an open position (FIG. 6D) and a fully closed position (FIG. 6E). In the open position, the set of egress apertures 29a of the outer cap 123 and the set of egress apertures 29b of the inner cap 121 are aligned. To assist the user in alignment, the outward protrusions 180 of the inner cap 121 are configured to engage the inward protrusions 192 of the outer cap 123 when the egress apertures 29a and 29b are substantially aligned. The outward and inward protrusions 180 and 192 also operate to assist the user in readily closing the sifter cap 102. The user can rotate the outer cap 123 away from the open position (i.e., in the clockwise direction in the embodiments of FIGS. 6D and 6E) until the inward protrusions 192 engage with the adjacent outward protrusions 180 of the inner cap 121. In the depicted embodiment, this operation registers the egress apertures 29a of the outer cap 121 about midway between the egress apertures 29b of the inner cap 121.

Referring to FIG. 7, a LUER lock assembly 200 is presented as an alternative to the threaded orifice 130 in an embodiment of the invention. The LUER lock assembly includes a male portion 202 and a female portion 204, the female portion 204 being part of or connected with the delivery tube 126. A distinction between the LUER lock assembly 200 and the cap/delivery tube 120 is that the threads are reversed. That is, the threads on sifter cap 102 are external and the threads on the delivery tube 126 are internal; for the cap/delivery tube 120, the threads on the sifter cap 102 are internal and the threads on the delivery tube 126 are external.

In operation, the user twists the female portion 204 at the base of the delivery tube 126 onto the male portion 202 located on the sifter cap 102. Between uses, the delivery tube 126 is stowed remotely from the container 24 and sifter cap 102.

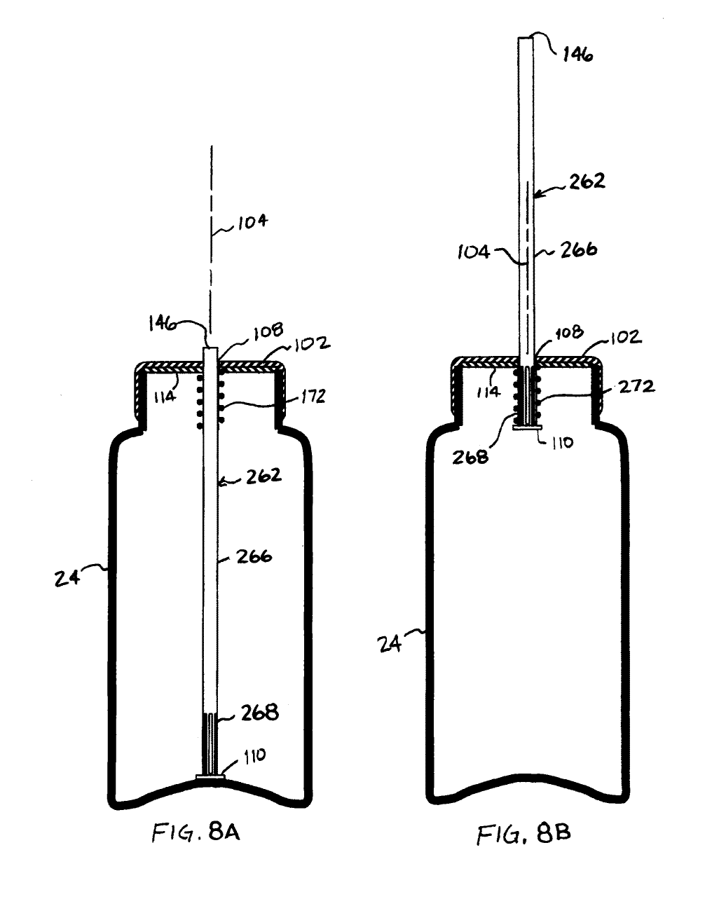

Referring to FIGS. 8A and 8B, yet another combination sifter cap/delivery tube 260 with integrated powder delivery train 262 is depicted in an embodiment of the invention. Aspects in common with other depicted embodiments are similarly numbered. The powder delivery train 262 includes a powder delivery tube 266 having through-slots or apertures 268 proximate the flange 110. The sifter cap 102 is operatively coupled to the neck portion 152 of the powder container 24 and includes a helical coil 272 centered about the orifice 108.

When the powder delivery tube 266 is in the stowed position (FIG. 8A), the delivery tube 266 acts to block powder from flowing between the orifice 108 and the delivery tube 266. The helical coil 272 acts to keep the delivery tube 266 in alignment with the center of the powder container 24 and prevents the delivery tube 266 from becoming canted and falling into the powder container 24. The length of the delivery tube 266 can be tailored so that the delivery tube 266 is proud with respect to the top of the sifter cap 102 when in the retracted position (as depicted).

Alternatively, the delivery tube 266 can be dimensioned so that it is substantially flush with or slightly recessed with respect to the top surface of the sifter cap 102 when the delivery tube 266 is fully retracted.

When the powder delivery tube 266 is in the extended position, the powder delivery tube also prevents powder from flowing out of the orifice 108. Powder that is within the powder container 24 can enter the train by flowing through the helical coil 272 and the slots 268. The length of the slots 268 and the axial length of the helical coil 272 can be coordinated so that powder can flow flush with the interior surface 114 into the delivery tube 266 while still providing a perimeter seal for the orifice 108.

The helical coil 272 may be comprised of a metal or a polymer that is molded into the interior surface 114. Other structures besides a helical coil that are of sufficient porosity can optionally be utilized, such as an expanded sleeve or an aperture sleeve.

In another embodiment (not depicted), the powder delivery train can comprise a telescoping structure that reduces the stowage length. Alternatively, the telescoping structure can remain exterior to the powder container instead of being stowed within, for applications where the telescoping structure in a non-extended configuration is of sufficiently low profile.

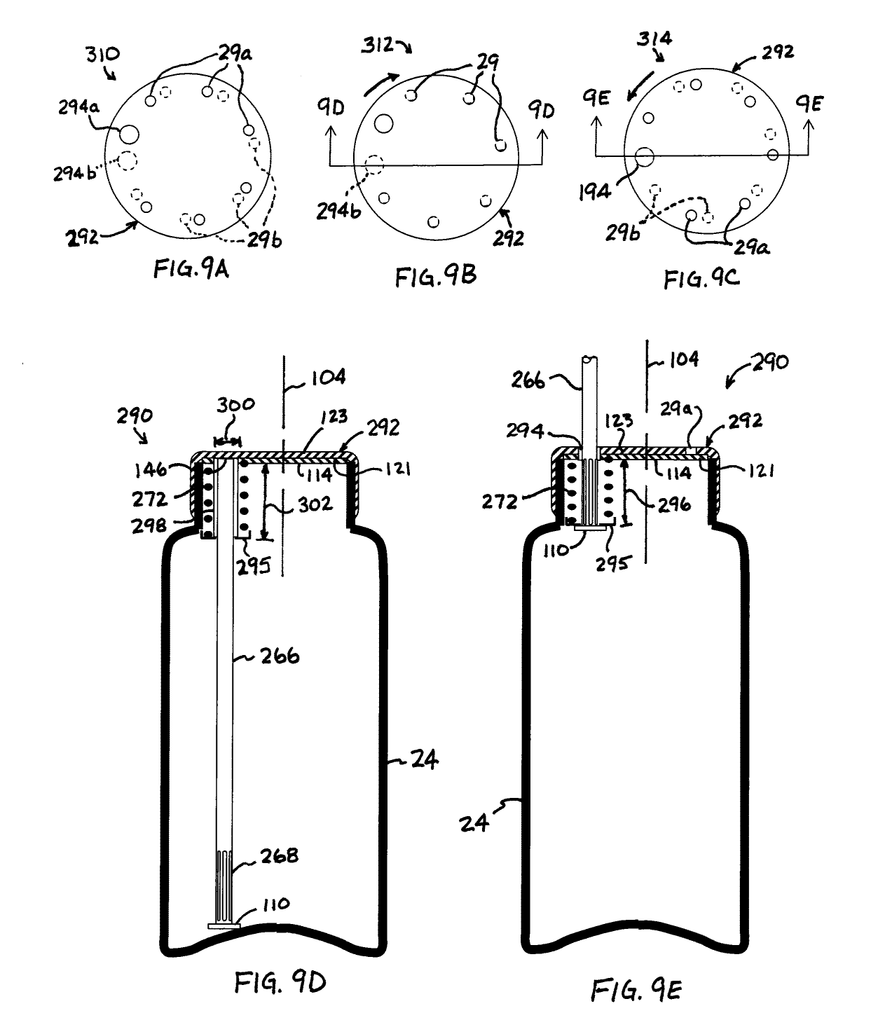

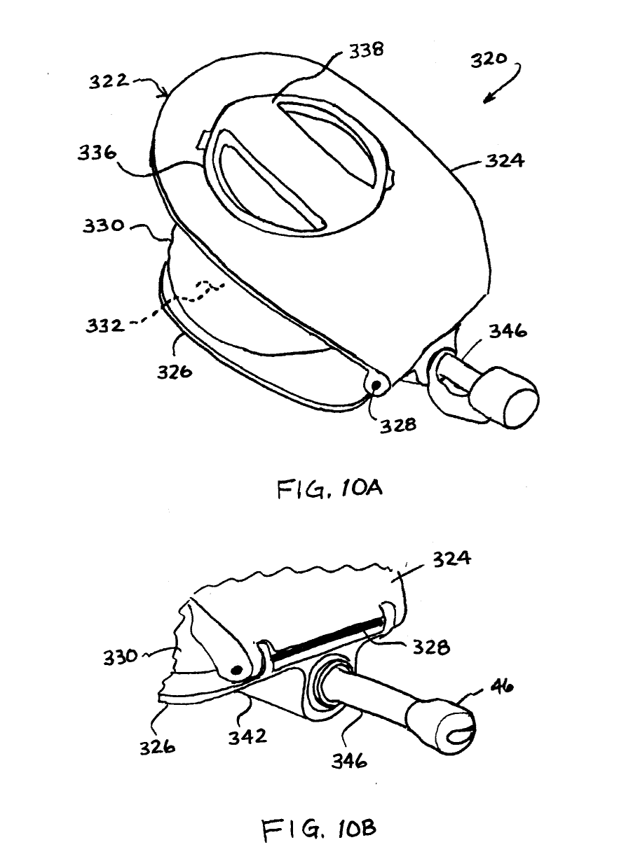

Referring to FIGS. 9A through 9E, a combination sifter cap/delivery tube 290 having a 3-position sifter cap 292 and an off-center orifice 294 for the powder delivery tube 266 is presented in an embodiment of the invention. The combination sifter cap/delivery tube 290 shares many of the same aspects as the combination sifter cap/delivery tube 260, which are like-numbered. In addition, delivery tube 290 includes a necked down collar 295 affixed to the end of the helical coil 272 that is opposite the interior surface 114. An interior length 296 of the helical coil 272 is defined between the interior surface 114 and the necked down collar 295. Also, the delivery tube 266 includes an increased outer diameter portion 298 having an outer diameter 300 and a length 302 proximate the distal end 146. The increased outer diameter 298 can be integrally formed with the delivery tube 266 or comprise a sleeve that is affixed proximate the distal end 146. In one embodiment, the outer diameter 300 can be dimensioned to slide within the inner diameter defined by the helical coil 272 while having a dimension that is greater than the inner diameter of the necked down collar 295. Also note that, in the depicted embodiment, the length 302 of the outer diameter portion 298 is greater than the interior length 296 of the helical coil 272.

The 3-position sifter cap 292 is capable of three distinct orientations, depicted in FIGS. 9A, 9B and 9C respectively. Note that the plurality of apertures are depicted as having two counterparts 29a and 29b, with 29a depicting the egress apertures on the outer cap 123 of the 3-position sifter cap 292 and 29b (depicted in phantom) depicting the egress apertures on the inner cap 121 of the 3-position sifter cap. Likewise, the off-center orifice 294 is depicted as having two counterparts—an outer orifice 294a and an inner orifice 294b—corresponding to the inner and outer caps 121 and 123, respectively, of the 3-position sifter cap 292.

In a first orientation 310 (FIG. 9A), herein referred to as the “closed position,” the 3-position sifter cap 292 effectively seals the egress apertures 29 and the off-center orifice 294. In a second orientation 312, which in the depiction of FIG. 9B is obtained by rotating the outer cap 123 of the 3-position sifter cap 292 in a clockwise direction from the closed position of FIG. 9A, the egress apertures 29a and 29b are in alignment, enabling powder to flow through the egress apertures 29a, 29b. In this second orientation 312, the powder delivery tube 266 is contained within the powder container 24, as depicted in FIG. 9D. A third orientation 314 (FIG. 9C), herein referred to as the “deploying position,” is obtained by rotating the outer cap 123 of the 3-position sifter cap 292 in a counter-clockwise direction from the closed position of FIG. 9A. In this third orientation 314, the egress apertures 29a and 29b are not in alignment and are effectively sealed. In this third orientation 314, the off-center orifice components 294a and 294b are in alignment, enabling the delivery tube 266 to be extracted from the powder container 24.

In operation, the closed position 310 is obtained by pushing the powder delivery tube 266 through the off-center orifice 294 until the distal end 146 is below the outer cap 123 of the 3-position sifter cap 292. This action causes the increased outer diameter portion 298 of the delivery tube 266 to register against the necked down collar 295. Also, because the length 302 of the outer diameter portion 298 is greater than the interior length 296 of the helical coil 272, the helical coil 272 is stretched, thus exerting an upward biasing force on the delivery tube 266. The outer cap 123 of the 3-position sifter cap is then rotated over the distal end 146 of the delivery tube 266 to capture the delivery tube 266 while the helical coil 272 remains extended and the upward biasing force remains exerted on the delivery tube 266.

When moving to the deploying position of FIG. 9C, the upward bias force causes the delivery tube 266 to eject into the off-center orifice 294, causing the distal end 146 to extend above the 3-position sifter cap 292. The extension enables the user to grasp the delivery tube 266 and pull it into the fully extended position depicted in FIG. 9E.

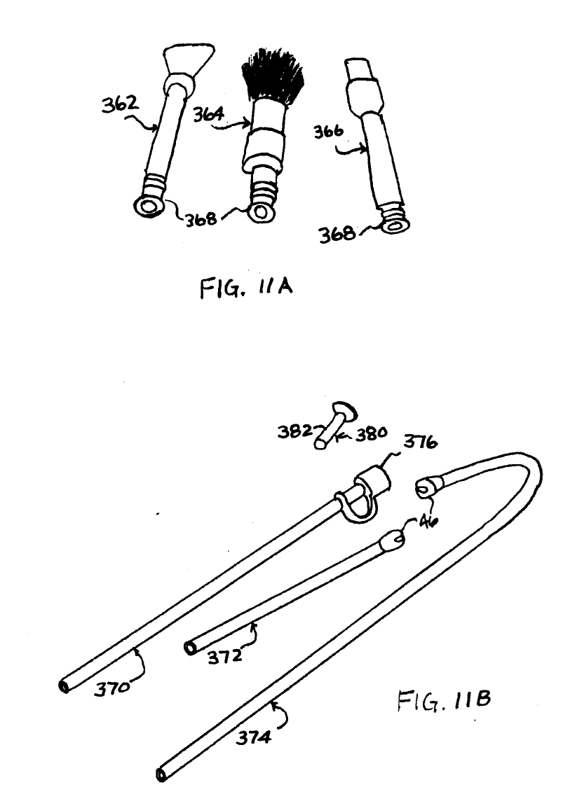

Referring to FIGS. 10A and 10B, a powder delivery system 320 including a bellows container 322 is depicted in an embodiment of the invention. The bellows container 322 comprises an upper portion 324 and a lower portion 326 that are connected on one side by a hinge member 328 in a clamshell arrangement. A bellows 330 is disposed between the upper and lower portions 324 and 326 to create a bellows chamber 332. The upper portion 324 can be configured with an access port 336 having a lid 338 for capping.

In one embodiment, a reservoir 342 depends from the lower portion 326, creating a cavity in the bottom of the bellows chamber 332. The reservoir 342 can be configured for attachment of a delivery tube 346.

In operation, the lid 338 is removed from the upper portion 324, providing access to the bellows chamber 332 via the access port 336. Powder is then deposited in the bellows chamber 332 and the lid 338 replaced to capture the powder within the bellows chamber 332. Actuation of the bellows container 322 is accomplished by squeezing the upper and lower portions 324 and 326 together. The actuation creates a pressure buildup in the bellows chamber 332, causing powder that is in the reservoir 342 to flow into and through the delivery tube 346, exiting the nozzle 46.

Referring to FIGS. 11A and 11B, delivery tube of various lengths and configurations are depicted in embodiments of the invention. In certain embodiments, the various delivery tubes can interchanged. Delivery tubes 362, 364 and 366 include LUER fittings 368 for adaptation to LUER-lock configurations (e.g., as depicted in FIGS. 3A and 3B), and depict a flat-flared nozzle, a brush nozzle and a flat nozzle, respectively. Delivery tubes 370, 372 and 374 are of varying length and contour. Delivery tube 370 includes a cap attachment 376 at the distal end for capping the delivery tube when not in use to prevent loss of powder during storage and transit, and to limit the infestation of atmospheric moisture into the powder contained within the powder container. A stop 380 comprising a solid rod member 382 can also be implemented to replace the powder delivery tube when the powder delivery system is not in use, thus reducing the profile of the powder container and keeping the powder dry within.

Another embodiment of the invention (not depicted) comprises a kit that includes a powder delivery system or a portion of a powder delivery system such as described herein in a retail package, the kit including instructions that outline the various assembly and operational steps for configuration.

References to relative terms such as upper and lower, front and back, left and right, or the like, are intended for convenience of description and are not contemplated to limit the invention, or its components, to any specific orientation. All dimensions depicted in the figures may vary with a potential design and the intended use of a specific embodiment of this invention without departing from the scope thereof.

Each of the additional figures and methods disclosed herein may be used separately, or in conjunction with other features and methods, to provide improved devices, systems and methods for making and using the same. Therefore, combinations of features and methods disclosed herein may not be necessary to practice the invention in its broadest sense and are instead disclosed merely to particularly describe representative embodiments of the invention.

What is claimed is:

1. A powder delivery train, comprising:
a cylindrical cap that defines a central axis, said cylindrical cap including a top portion,
a continuous skirt portion that depends from said top portion, said skirt portion including a continuous flexible seal portion having a softer durometer hardness than said top portion, said skirt portion defining an opening opposite said top portion, said opening being dimensioned for coupling with and sealing against the perimeter of a conventional sifter cap, and
structure defining a port that passes through said top portion; and
a delivery tube having a proximal end and a distal end, said delivery tube being operatively coupled with said port so that said proximal end of said delivery tube is adapted for fluid communication with the interior of said powder container.

2. The powder delivery train of claim 1, further comprising a nozzle selectively attached to said distal end of said delivery tube.

3. The powder delivery train of claim 1 wherein said skirt portion is integral with said top portion.

4. The powder delivery train of claim 1 wherein said skirt portion is bonded to said top portion.

5. The powder delivery train of claim 1 wherein said continuous flexible seal portion comprises an o-ring.

6. The powder delivery train of claim 1 wherein said delivery tube is adapted to be selectively retractable into said powder container.

7. The powder delivery train of claim 1 wherein said outlet of said powder container includes a sifter cap.

8. The powder delivery train of claim 1 wherein said skirt portion is of a softer durometer hardness than said top portion.

9. The powder delivery train of claim 1 wherein said port that passes through said top portion is located on said central axis of said cylindrical cap.

10. A powder delivery system, comprising:
a powder container having a neck portion, said powder container defining an interior chamber;
a sifter cap operatively coupled to said neck portion, said sifter cap including an inner cap and an outer cap, said inner cap including structure defining a first set of egress apertures, said outer cap including structure defining a second set of egress apertures, said inner cap and said outer cap being adapted rotate about a central axis to selectively align said second set of egress apertures with said first set of egress apertures;
structure defining a first orifice on said outer cap;
structure defining a second orifice on said inner cap; and
a delivery tube in fluid communication with said first orifice, said second orifice and said interior chamber.

11. The powder delivery system of claim 10 wherein said first and second orifices are substantially aligned along said central axis.

12. The powder delivery system of claim 11 wherein said second orifice passes through said first orifice.

13. The powder delivery system of claim 12 wherein said second orifice includes one of internal and external threads.

14. The powder delivery system of claim 13 wherein said delivery tube is adapted to engage said one of internal and external threads.

15. The powder delivery system of claim 10 wherein said first and second orifices are adapted to selectively align by rotation of said outer cap about said inner cap.

16. The powder delivery system of claim 10 wherein said delivery tube is retractable into said interior chamber.
